(19) United States
(12) Patent Application Publication
(10) Pub. No.: US 2025/0068767 A1
(43) Pub. Date: Feb. 27, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Koichi SATO, Kanagawa (JP)

(73) Assignee: FUJIFILM Business Innovation Corp., Tokyo (JP)

(21) Appl. No.: 18/438,001

(22) Filed: Feb. 9, 2024

(30) Foreign Application Priority Data
Aug. 22, 2023 (JP) 2023-134797

(51) Int. Cl. G06F 21/62; G06T 7/00

(52) U.S. Cl. CPC G06F 21/6254; G06T 7/0002; G06T 2207/20044

(57) ABSTRACT

An information processing system includes a processor, in which the processor acquires image data indicating a captured image, and in a case where the image shows a disallowed target object whose identification information for identifying an individual is not allowed to be provided, generates accompanying information of the image data without including the identification information regarding the disallowed target object.

### CROSS-REFERENCE TO RELATED APPLICATIONS

This application is based on and claims priority under 35 USC 119 from Japanese Patent Application No. 2023-134797 filed Aug. 22, 2023.

### BACKGROUND

### (i) Technical Field

The present disclosure relates to an information processing system, a non-transitory computer readable medium storing an information processing program, and an information processing method.

### (ii) Related Art

JP2002-142214A discloses a video monitoring system configured of imaging means that transmits an imaging condition from a monitoring location to perform imaging, recognition means that recognizes a human body based on imaging information of an output of the imaging means, abstracting means that abstracts information regarding the human body based on an output of the recognition means, synthesizing means that synthesizes the output of the abstracting means and the output of the imaging means, and an information transmission line that transmits the output of the synthesizing means to the monitoring location.

JP2023-006192A discloses a position information system including a server having a function of finding out a position of a mobile terminal or a portable transmitter that performs short-range communication with a transmitter and/or a receiver based on received unique information of the transmitter or the receiver, in which the server includes area setting means that sets a privacy protection area in a random area of a predetermined area within a management area, area determination means that finds out the position of the mobile terminal or the portable transmitter that performs short-range communication with the transmitter and/or the receiver based on the unique information of the transmitter or the receiver and determines whether or not the found position is within the privacy protection area, and information transmission means that transmits the found position of the mobile terminal or the portable transmitter, map information of the management area including the position, and determination result information from the area determination means. In a case where the position of the mobile terminal or the portable transmitter is determined to be within the privacy protection area in normal use, browsing of personal information of a holder of the mobile terminal or the portable transmitter is disabled. On the other hand, in a case where the position of the mobile terminal or the portable transmitter is determined to be within the privacy protection area in emergency use, browsing of personal information of a holder of the mobile terminal or the portable transmitter is enabled.

### SUMMARY

In a system that acquires information from an image obtained by capturing a space, an information system that enables browsing of personal information in emergency use is known. In such an information system, the browsing of the personal information of all persons is enabled. Thus, there is a problem that the personal information of a person not allowed to be browsed may be browsed. Such a problem is not limited to the information regarding persons, and the same applies to information regarding animals (for example, pets) and possessions (for example, robots).

Aspects of non-limiting embodiments of the present disclosure relate to an information processing system, a non-transitory computer readable medium storing an information processing program, and an information processing method that are capable of preventing generation of information for identifying an individual for a target object that is not allowed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system includes a processor, in which the processor acquires image data indicating a captured image, and in a case where the image shows a disallowed target object whose identification information for identifying an individual is not allowed to be provided, generates accompanying information of the image data without including the identification information regarding the disallowed target object.

### BRIEF DESCRIPTION OF THE DRAWINGS

Exemplary embodiment(s) of the present invention will be described in detail based on the following figures, wherein:

FIG. 1 is a diagram showing an example of a schematic configuration of an information providing system 10 according to the present exemplary embodiment;

FIG. 2 is a diagram showing an example of a hardware configuration of an information processing system 100 according to the present exemplary embodiment;

FIG. 3 is a diagram showing an example of a functional configuration of the information processing system 100 according to the present exemplary embodiment;

FIG. 4 is a table showing an example of registration information stored in the information processing system 100 according to the present exemplary embodiment;

FIG. 5 is a diagram showing an example of a flow of information processing executed by the information processing system 100 according to the present exemplary embodiment; and

FIG. 6 shows an example of accompanying information generated by the information processing system 100 according to the present exemplary embodiment.

### DETAILED DESCRIPTION

Hereinafter, an example of the exemplary embodiment of the present disclosure will be described with reference to drawings. Identical reference numerals are assigned to identical or equivalent components and parts in each drawing. In addition, a dimensional ratio in the drawing is exaggerated for convenience of description and may differ from an actual ratio.

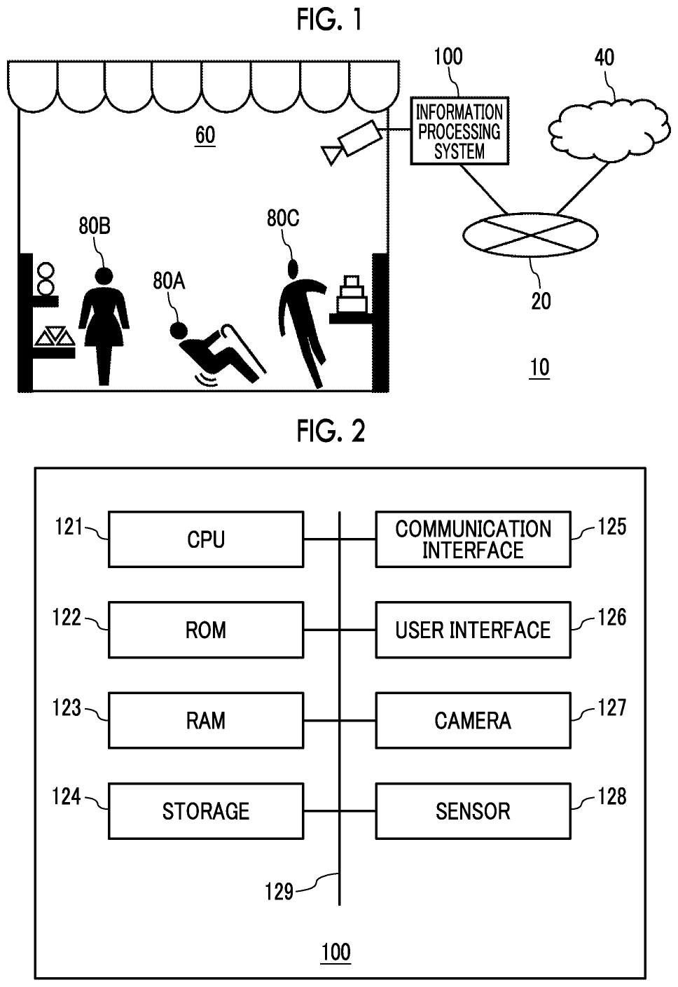

FIG. 1 is a diagram showing an example of a schematic configuration of an information providing system 10 according to the present exemplary embodiment. The information providing system 10 includes a communication unit 20, a cloud system 40, and an information processing system 100.

The communication unit 20 connects a plurality of computers in a communicable manner. In the present figure, the communication unit 20 connects the cloud system 40 and the information processing system 100. The communication unit 20 may be, for example, various networks such as LAN, WAN, the Internet, or an intranet. In addition, the communication unit 20 may connect the plurality of computers wirelessly or by wire.

The cloud system 40 is a computer system that uses cloud computing. The cloud system 40 provides various services to a user via the communication unit 20. In the present exemplary embodiment, the cloud system 40 acquires accompanying information generated from image data of a space 60 described below from the information processing system 100, and provides various services to the user by using the accompanying information.

The space 60 is a space to be imaged. In the present figure, a case is shown as an example in which the space 60 is a store and target objects 80A, 80B, and 80C (collectively referred to as “target object 80” in a case where there is no need to distinguish), which are a plurality of persons, are present in the store. The space 60 is not limited to the store, and may be any space in which an image can be captured, such as an office, a factory, a hospital, or a medical field. In addition, the target object 80 is not limited to a person, and may be any object for which there may be a problem that information for identifying an individual such as an animal (for example, a pet) or a possession (for example, a robot) is generated without allowance.

The information processing system 100 acquires the image data indicating an image obtained by capturing the space 60, and generates the accompanying information of the image data. Here, in a case where the accompanying information is generated from the image data of the space 60, there may be a problem that identification information for identifying an individual such as personal information or privacy information is generated without allowance. The information processing system 100 according to the present exemplary embodiment generates the accompanying information without including the identification information regarding a disallowed target object 80 whose identification information is not allowed to be provided. The above will be described in detail.

FIG. 2 is a diagram showing an example of a hardware configuration of the information processing system 100 according to the present exemplary embodiment. The information processing system 100 includes a CPU 121, a ROM 122, a RAM 123, a storage 124, a communication interface 125, a user interface 126, a camera 127, and a sensor 128. The above configurations are communicably connected to each other via a bus 129.

The CPU 121 is a central calculation processing unit, and executes various programs to control each configuration. The ROM 122 stores various programs and various types of data. The RAM 123 transitorily stores the program or the data, as a work area. The storage 124 is configured of a hard disk drive (HDD) or a solid state drive (SSD), and stores various programs including an operating system and various types of data.

In the information processing system 100 according to the present exemplary embodiment, an information processing program is stored in the ROM 122 or the storage 124. The CPU 121 reads out a target program from the ROM 122 or the storage 124, and executes the program using the RAM 123 as a work area. The CPU 121 executes control of each configuration and various types of calculation processing according to the program.

The communication interface 125 is an interface for the information processing system 100 to communicate with other devices. The user interface 126 is an input/output interface for the information processing system 100 to exchange information with the user. The user interface 126 may include, for example, a keyboard, a mouse, or a microphone as an input device, and a monitor or a speaker as an output device.

The camera 127 captures an image of the space 60 with an imaging element such as a CCD or CMOS. The “image” may be interpreted to include both a still image and a moving image. The camera 127 outputs the image data indicating the image obtained by capturing the space 60.

The sensor 128 measures various physical quantities. As an example, the sensor 128 may be a fire sensor, an earthquake sensor, or a pulse sensor. The sensor 128 outputs, as sensor data, a measured value obtained by measuring the physical quantity or a calculation result obtained by performing a predetermined calculation on the measured value.

In the above description, a case where the sensor 128 is provided inside the information processing system 100 is shown as an example, but the present disclosure is not limited thereto. The sensor 128 may be externally attached to an outside of the information processing system 100. In this case, the sensor 128 may be communicably connected to the information processing system 100 via the communication unit 20.

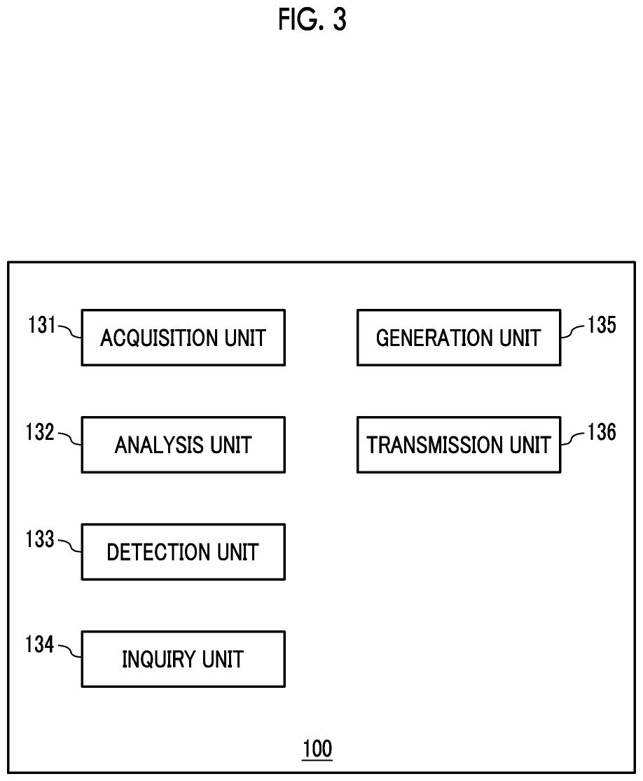

FIG. 3 is a diagram showing an example of a functional configuration of the information processing system 100 according to the present exemplary embodiment. The information processing system 100 includes an acquisition unit 131, an analysis unit 132, a detection unit 133, an inquiry unit 134, a generation unit 135, and a transmission unit 136. The above functional configurations are realized by the CPU 121 reading out the information processing program from the ROM 122 or the storage 124, expanding the information processing program into the RAM 123, and executing the information processing program.

The acquisition unit 131 acquires image data indicating a captured image.

The analysis unit 132 analyzes the image data acquired by the acquisition unit 131.

The detection unit 133 detects that a predetermined abnormality has occurred.

The inquiry unit 134 inquires about registration information in a case where the detection unit 133 detects that the predetermined abnormality has occurred.

In a case where the disallowed target object 80 whose identification information for identifying an individual is not allowed to be provided is shown in the image, the generation unit 135 generates the accompanying information of the image data acquired by the acquisition unit 131 without including the identification information regarding the disallowed target object 80, according to an inquiry result from the inquiry unit 134.

The transmission unit 136 transmits the accompanying information generated by the generation unit 135 to the outside of the information processing system 100 via the communication unit 20.

Hereinafter, a flow will be described in detail in which the information processing system 100 having such a hardware configuration and a functional configuration executes information processing. However, the information processing system 100 may store the registration information in advance prior to the flow.

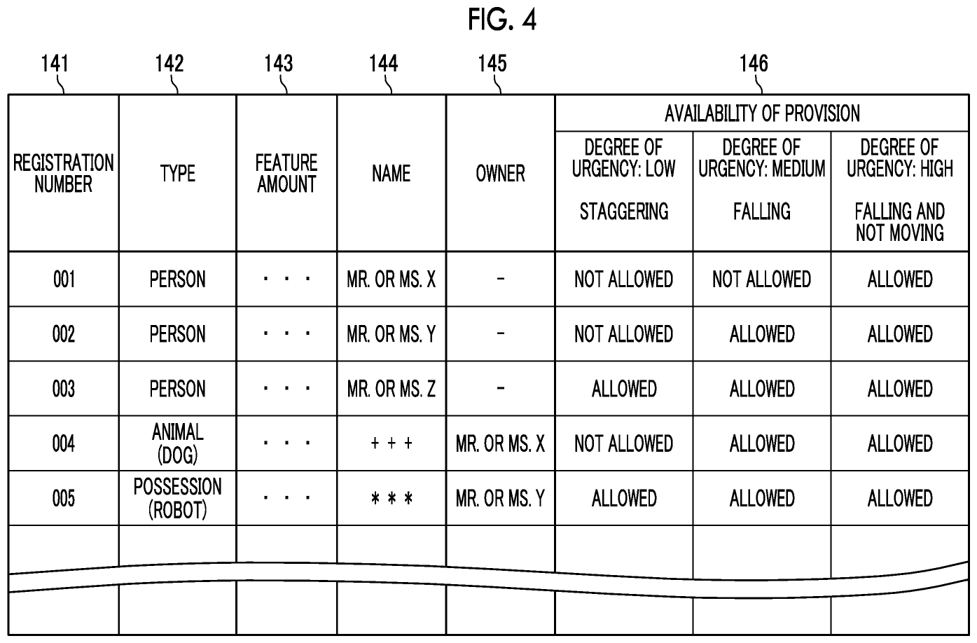

FIG. 4 is a table showing an example of the registration information stored in the information processing system 100 according to the present exemplary embodiment. The registration information includes a first item 141, a second item 142, a third item 143, a fourth item 144, a fifth item 145, and a sixth item 146.

The first item 141 is an item indicating a registration number. Different registration numbers may be assigned to the target objects 80, for example, in an order of registration.

The second item 142 is an item indicating a type of the target object 80. In a case where the target object 80 is a person, the item may be registered as “person”. In a case where the target object 80 is a dog as a pet, the item may be registered as “animal (dog)”. In a case where the target object 80 is a robot as a possession, the item may be registered as “possession (robot)”.

The third item 143 is an item indicating a feature amount for identifying the target object 80 from the image. The feature amount may be an amount extracted from an image showing the target object 80. As an example, in a case where the target object 80 is a person, the feature amount may be data obtained by quantifying positions, sizes, colors, and the like of a contour, an eye, a nose, a mouth, and an ear of a face extracted from a face image.

The fourth item 144 is an item indicating a name of the target object 80. In a case where the target object 80 is a person, a name of an individual may be registered in the item. In a case where the target object 80 is a pet or a robot, a name given by an owner may be registered in the item.

The fifth item 145 is an item indicating the owner of the target object 80. In a case where the target object 80 is a person, the item may be blank. Instead of the above, in a case where the target object 80 is a minor person, a name of a guardian may be registered in the item. In a case where the target object 80 is a pet or a robot, a name of the owner (per owner, purchaser, or the like) may be registered in the item.

The sixth item 146 is an item indicating availability of the provision of the identification information. An “Allowed” mark means that the provision of the identification information is allowed, that is, the provision of the identification information is consented. A “Not Allowed” mark means that the provision of the identification information is not allowed.

The availability of provision as described above may be registered for each degree of abnormality. In the present figure, with a case where the target object 80 staggers as “degree of urgency: low”, a case where the target object 80 falls as “degree of urgency: medium”, and a case where the target object 80 falls and does not move as “degree of urgency: high”, the availability of provision is registered for each case. For example, for “Mr. or Ms. X” with a registration number 001, the present figure shows that the provision of the identification information is not allowed in the case of staggering or falling, and the provision of the identification information is allowed only in the case of falling and not moving. On the other hand, for “Mr. or Ms. Z” of a registration number 003, the present figure shows that the provision of the identification information is allowed in all cases of staggering, falling, and falling and not moving.

In the present figure, the case is shown as an example in which the falling or the like is assumed as the abnormality, but the present disclosure is not limited thereto, and various abnormalities may be assumed. For example, an earthquake may be assumed as the abnormality. In this case, a seismic intensity may be used as a degree of abnormality, and the availability of provision may be registered for each seismic intensity. Various abnormalities such as a fire, a crime, a fall from a bed in a hospital or a medical field, or a change in a state of consciousness may be additionally assumed.

The information processing system 100 may store such registration information in advance in the ROM 122 or the storage 124. The registration information may be stored outside the information processing system 100. However, in such a case, there is a need to transmit the image to the outside each time the information processing system 100 collates the registration information, which may lead to leakage of personal information or privacy information. For this reason, the registration information is stored in preference, for example, inside the information processing system 100.

Even in such a case, registration processing itself of the registration information may be executed via the cloud or the like. That is, the user who wants registration may upload the face image or the like via the cloud or the like to register the name or the availability of provision. Next, the feature amount may be extracted in the cloud or the like. The information processing system 100 may acquire the registration information as shown in the present figure from the cloud or the like. With the execution of the registration processing via the cloud or the like in this manner, there is no need to extract the feature amount in the information processing system 100, and thus, a processing load in the information processing system 100 can be reduced. In addition, there is no need to store the image itself such as the face image in the information processing system 100, and thus, tightness of storage capacity in the information processing system 100 can be suppressed.

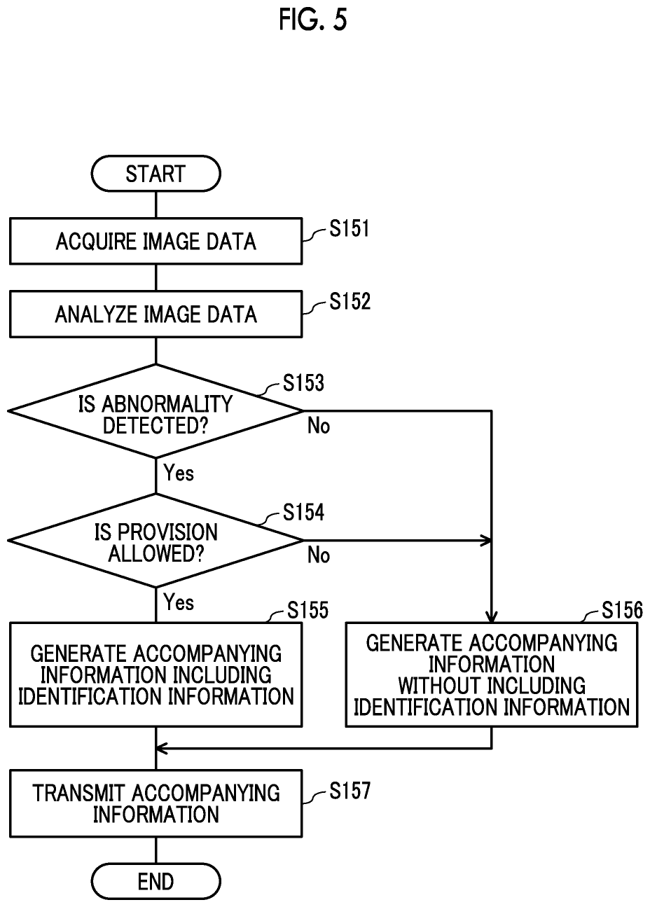

FIG. 5 is a diagram showing an example of a flow of the information processing executed by the information processing system 100 according to the present exemplary embodiment. The present flow is executed by the CPU 121 reading out the information processing program from the ROM 122 or the storage 124, expanding the program into the RAM 123, and executing the program.

In step S151, the CPU 121 acquires, as the acquisition unit 131, the image data indicating the image of the space 60 captured by the camera 127.

In step S152, the CPU 121 analyzes, as the analysis unit 132, the image data acquired in step S151. For example, the CPU 121 analyzes the image data with artificial intelligence (AI) to detect an object including the target object 80. In this case, the CPU 121 may use You Only Look Once (YOLO) or the like, as an AI model, to detect a type or a position of the object in the image.

In addition, the CPU 121 may acquire skeleton information by using high resolution network (HRNet) or the like, as the AI model, to estimate a posture or a position of a skeleton of the target object 80 in the image.

In step S153, the CPU 121 determines, as the detection unit 133, whether or not the predetermined abnormality is detected. For example, the CPU 121 determines whether or not the abnormality is detected in the target object 80, based on a result of the analysis in step S152. As an example, the CPU 121 detects, in a case where the target object 80A is recognized to fall, that the abnormality has occurred in the target object 80A, based on a result of the posture estimation in step S152. In a case where the abnormality is detected in step S153 (in case of Yes), the CPU 121 advances the processing to step S154.

In step S154, the CPU 121 determines, as the inquiry unit 134, whether or not the provision of the identification information is allowed. For example, in a case where the target object 80A is recognized to fall, the CPU 121 inquires about the registration information and checks whether or not the target object 80A is registered. In this case, assumption is made that the type of the target object 80A is known to be a person by the object detection. In this case, the CPU 121 first sets the second item 142 of the registration information to “person” and filters the registration information. Accordingly, the registration numbers 001, 002, and 003 are extracted, and registration numbers 004 and 005 are excluded. Next, the CPU 121 collates the image of the target object 80A with the feature amounts of the third item 143 in the registration numbers 001, 002, and 003. Accordingly, the CPU 121 identifies that the target object 80A is “Mr. or Ms. Z” of the registration number 003 as a result of face authentication. As described above, with the collation after the filtering of the registration information according to the type of the target object 80, the CPU 121 can cause a time required for the identification processing to be reduced and the identification accuracy to be improved.

The CPU 121 refers to the sixth item 146 of the registration number 003 to determine the availability of the provision of the identification information in the case of falling. In a case where checking is made that a field of “degree of urgency: medium (falling)” is marked with “Allowed”, the CPU 121 determines that the provision of the identification information is allowed. That is, the CPU 121 determines that the target object 80A is an allowed target object 80 whose identification information is allowed to be provided in the case of falling. In a case where the provision of the identification information is determined to be allowed in step S154 (in the case of Yes), the CPU 121 advances the processing to step S155.

In step S155, the CPU 121 generates, as the generation unit 135, the accompanying information of the image data acquired in step S151, including the identification information of the target object 80A. That is, in a case where the predetermined abnormality has occurred and the allowed target object 80 whose identification information is allowed to be provided is shown in the image, the CPU 121 generates the accompanying information including the identification information regarding the allowed target object 80.

Here, the “accompanying information” may be meta information of the image data as an example. The meta information may be expressed in, for example, an extensible markup language (XML) format or a javascript (registered trademark) object notation (JSON) format.

The meta information may include object information regarding an object other than the target object 80 in the image. The object information regarding the object other than the target object 80 may include a name of the object in the space 60, coordinates thereof, and recognition probability information indicating a probability that the name and the coordinates are recognized from the image data.

In addition, the meta information may include the skeleton information regarding the target object 80 in the image. The skeleton information regarding the target object 80 may include coordinates of each of a face, an eye, an ear, a shoulder, a hip, a hand, a foot, and the like of the target object 80, and the recognition probability information indicating a probability that the face, the eye, the ear, the shoulder, the hip, the hand, the foot, and the like are recognized from the image data. An individual target object 80 may not be identified only by such skeleton information. The CPU 121 generates the skeleton information regarding the target object 80 by including the skeleton information in the accompanying information regardless of the availability of provision.

In addition, the meta information may include the identification information regarding the target object 80 in the image. The identification information regarding the target object 80 may include a name of the target object 80, the recognition probability information indicating a probability that the name is recognized from the image data, and an image showing the target object 80. Such a name of the target object 80 or an image showing the target object 80 may identify the individual target object 80. The CPU 121 generates the identification information by including the identification information in the accompanying information only in a case where the provision of the identification information is allowed.

In a case where a plurality of target objects 80 are detected as a result of analyzing the image data in step S152, the CPU 121 repeatedly executes the processing of steps S153 to S156 for each of the plurality of target objects 80. In a case where the target object 80B is further detected in step S152, in step S153, the CPU 121 determines whether or not the abnormality is detected in the target object 80B. As an example, the CPU 121 determines, in a case where the target object 80B is recognized not to fall and not to stagger, that no abnormality is detected in the target object 80B, based on the result of the posture estimation in step S152. In a case where no abnormality is detected in step S153 (in the case of No), the CPU 121 advances the processing to step S156.

In step S156, the CPU 121 generates, as the generation unit 135, the accompanying information of the image data acquired in step S151 without including the identification information of the target object 80B. That is, in a case where the abnormality has not occurred, the CPU 121 generates the accompanying information without including the identification information regarding the disallowed target object 80 and the allowed target object 80. As described above, in a case where no abnormality is detected, the CPU 121 generates the accompanying information without including the identification information of the target object 80 without determining the allowance for the provision of the identification information. For the accompanying information that is already generated, the CPU 121 does not have to generate the accompanying information in duplicate.

In a case where the target object 80C is further detected in step S152, in step S153, the CPU 121 determines whether or not the abnormality is detected in the target object 80C. As an example, the CPU 121 detects, in a case where the target object 80C is recognized to stagger, that the abnormality has occurred in the target object 80C, based on a result of the posture estimation in step S152. In a case where the abnormality is detected in step S153, the CPU 121 advances the processing to step S154.

In step S154, in a case where the target object 80C is recognized to stagger, the CPU 121 inquires about the registration information to check whether or not the target object 80C is registered. The CPU 121 identifies that the target object 80C is “Mr. or Ms. X” of the registration number 001. The CPU 121 refers to the sixth item 146 of the registration number 001 to determine the availability of the provision of the identification information in the case of staggering. In a case where checking is made that a field of “degree of urgency: low (staggering)” is marked with “Not Allowed”, the CPU 121 determines that the provision of the identification information is not allowed. That is, the CPU 121 determines that the target object 80C is the disallowed target object 80 for which the provision of the identification information is not allowed in the case of staggering. The CPU 121 may determine that the target object 80 that is not registered in the registration information is the disallowed target object 80. In a case where the provision of the identification information is determined to be not allowed in step S154 (in the case of No), the CPU 121 advances the processing to step S156.

In step S156, the CPU 121 generates the accompanying information of the image data acquired in step S151 without including the identification information of the target object 80C. That is, in a case where the disallowed target object 80 whose identification information for identifying an individual is not allowed to be provided is shown in the image, the CPU 121 generates the accompanying information of the image data without including the identification information regarding the disallowed target object 80. As described above, even in a case where the abnormality is detected, in a case where the identification information is not allowed to be provided, the CPU 121 generates the accompanying information without including the identification information of the target object 80.

In step S157, the CPU 121 transmits, as the transmission unit 136, the accompanying information generated in steps S155 and S156 to a cloud system 40, which is outside the information processing system 100, via the communication unit 20. The information processing system 100 ends the present flow.

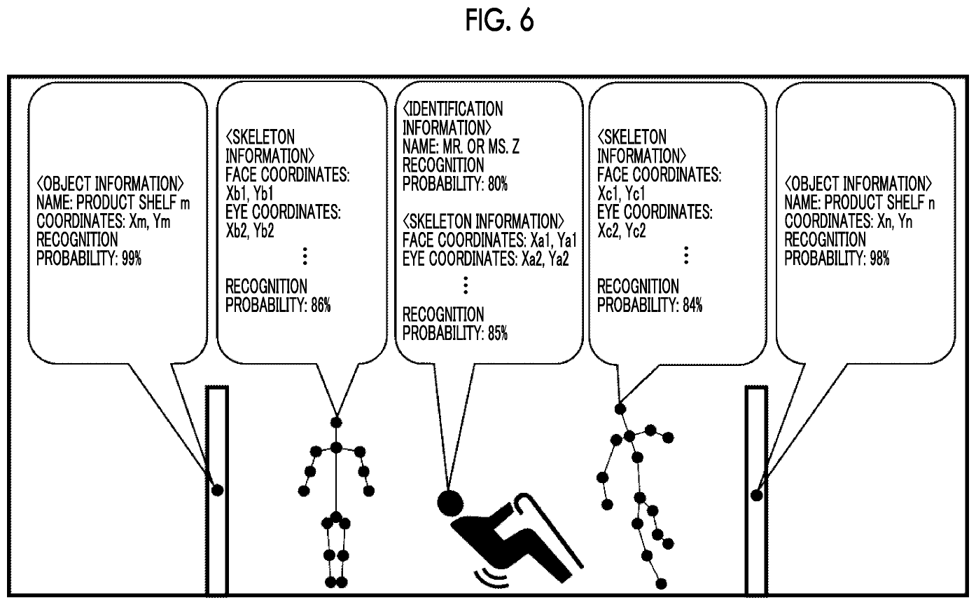

FIG. 6 shows an example of the accompanying information generated by the information processing system 100 according to the present exemplary embodiment. The present figure shows the accompanying information in a case where the target object 80A, the target object 80B, the target object 80C, a product shelf m, and a product shelf n are shown in the image.

The product shelf m and the product shelf n are objects other than the target object 80. Thus, the accompanying information may include a name of the product shelf, coordinates thereof, and the recognition probability information thereof, as the object information regarding the product shelf m and the product shelf n. The accompanying information may further include additional information such as a manufacturer, a model number, and dimensions of the product shelf, as the object information.

The target object 80A is the allowed target object 80 whose identification information is allowed to be provided. Therefore, the accompanying information may include the name of the target object 80A, the recognition probability information thereof, and the image of the target object 80A, as the identification information regarding the target object 80A. In addition, the accompanying information may include coordinates of each of a face, an eye, an ear, a shoulder, a hip, a hand, a foot, and the like of the target object 80A, and the recognition probability information thereof, as the skeleton information regarding the target object 80A.

The target object 80B and the target object 80C are the disallowed target object 80 whose identification information is not allowed to be provided. Therefore, the accompanying information may include coordinates of each of faces, eyes, ears, shoulders, hips, hands, feet, and the like of the target object 80B and the target object 80C, and the recognition probability information thereof, as the skeleton information regarding the target object 80B and the target object 80C.

In the related art, a network camera has been used as recording means that checks a past image in an emergency event. In recent years, with advances in AI technology such as deep learning, an object or a person shown in an image can be recognized in real time and with high accuracy, and AI technology is utilized in various fields. Examples of utilization include detection of a congestion situation in a restaurant, unmanned payment at a store, detection of an intruder for crime prevention, and detection of a person falling or an accident.

In order to analyze an image in real time, processing of transmitting, to the cloud or a high-performance edge server, a moving image captured by a camera as stream information to analyze the moving image with an AI engine of the cloud or the edge server is performed. However, in recent years, an AI camera having a hardware accelerator on a camera side and performing image analysis on the camera side has been put into practical use.

An advantage of performing AI processing on the camera side includes privacy protection, network traffic reduction, or the like. That is, in the network camera in the related art, the moving image necessary for the analysis is transmitted via a network in analyzing the moving image with the cloud or the edge server, and thus, there is a risk that personal information or privacy information may leak from the image being transmitted. On the other hand, in an endpoint AI camera that performs the AI processing in the camera, the image is analyzed in the camera and transmitted to the outside as meta information excluding the personal information or the privacy information. As described above, since the configuration is employed in which the personal information or the privacy information is not flown on the network, the risk of leakage of the personal information or the privacy information can be reduced. In addition, in a case where the image is analyzed in the AI camera, there is no need to transmit the moving image to the outside, and thus, a communication amount can be extremely reduced.

However, since the endpoint AI camera that executes the AI processing in the camera transmits only the meta information excluding the personal information or the privacy information to the outside, there is a problem that information is insufficient and flexible response cannot be performed in an emergency event. For example, in a camera that analyzes a congestion situation, movement of a person is analyzed from image data, and information on the number and position of people in a space is transmitted to the outside as meta information. In such a camera, in a case where falling of a person is detected, the event can be notified to the outside. However, since the personal information or the privacy information is excluded, there may be a case where the fallen individual cannot be identified and a prompt response is difficult to be made.

For such a problem, in an emergency event, there is known a method of performing the transmission to the outside including the personal information such as a name or an image of a fallen person or the privacy information in the meta information. Here, a camera that performs only detection of an emergency event without collecting the personal information or the privacy information can be treated as a kind of sensor, whereas a camera that transmits the personal information or the privacy information to the outside in this manner needs to follow a privacy guideline, as with a general network camera, and thus, is difficult to be installed in a public place such as a hospital or a school.

In a case where the image data is acquired and the disallowed target object 80 whose identification information is not allowed to be provided is shown in the image, the information processing system 100 according to the present exemplary embodiment generates the accompanying information of image data without including the identification information regarding the disallowed target object 80. Accordingly, with the information processing system 100, the information for identifying an individual for a target object that is not allowed may be prevented from being generated.

The above exemplary embodiment can be modified into various shapes and can be applied to various uses. For example, in the above description, the case is shown as an example in which the CPU 121 detects that the abnormality has occurred in the target object 80 by using the image data. However, instead of or in addition to the above, the CPU 121 may receive sensor data from the sensor 128 such as a pulse sensor, and may detect that the abnormality has occurred in the target object 80 by using the sensor data. In addition, in the above description, the case is shown as an example in which the determination is made whether or not the abnormality is detected for each target object 80. However, instead of or in addition to the above, the CPU 121 may determine whether or not the abnormality is detected for each space 60. For example, the CPU 121 may receive sensor data from the sensor 128 such as a fire sensor or an earthquake sensor, and may detect that the abnormality has occurred in the space 60 by using the sensor data. In addition, the CPU 121 may acquire a voice or a message such as “a person has fallen”, “an earthquake has occurred”, or “a fire has occurred” via the user interface 126, and may detect that the abnormality has occurred based on the voice or the message.

In addition, in the above description, only the case is shown as an example in which the CPU 121 transmits the generated accompanying information to the outside. However, in addition to the above, the CPU 121 may display the accompanying information to be transmitted to the outside on a predetermined display unit. As an example, the CPU 121 may display the accompanying information to be transmitted to the outside on a monitor included in the user interface 126. With disposition of such a monitor in a security room, a backyard, or the like of a store, the accompanying information may be visualized not to interfere with the business of the store. In addition, in a case where the monitor is provided integrally with the camera 127, the CPU 121 may display the accompanying information to be transmitted to the outside on the monitor provided integrally with the camera 127. Accordingly, the accompanying information may be visualized at a field where the imaging is actually performed. As a timing of transmitting the accompanying information, the CPU 121 may display the accompanying information every time the accompanying information is transmitted to the outside, may display the accompanying information at a predetermined cycle, may display the accompanying information in a case where the abnormality is detected, or may display the accompanying information in a case where a predetermined user input is made.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, although the information processing system 100 in the present exemplary embodiment is described as being configured by a single device as an example, the information processing system 100 may be configured by a plurality of devices.

The processing performed in the information processing system 100 according to the above exemplary embodiment may be processing performed by software, processing performed by hardware, or processing performed by a combination of the software and the hardware. The processing performed in each part of the information processing system 100 may be stored in a storage medium as a program and distributed.

In addition, the present disclosure is not limited to the above description, and various modifications other than the above description may be made without departing from the gist thereof.

Regarding the above exemplary embodiments, the following supplementary notes will be further disclosed.

(((1)))

An information processing system comprising:
a processor configured to:
acquire image data indicating a captured image; and
in a case where the image shows a disallowed target object whose identification information for identifying an individual is not allowed to be provided, generate accompanying information of the image data without including the identification information regarding the disallowed target object.

(((2)))

The information processing system according to (((1))), wherein the processor is configured to:
in a case where the image shows an allowed target object whose identification information is allowed to be provided, generate the accompanying information including the identification information regarding the allowed target object.

(((3)))

The information processing system according to (((2))), wherein the processor is configured to:
in a case where a predetermined abnormality occurs and the allowed target object is shown in the image, generate the accompanying information including the identification information regarding the allowed target object.

(((4)))

The information processing system according to (((3))), wherein the processor is configured to:
detect that the abnormality has occurred using the image data.

(((5)))

The information processing system according to (((3))) or (((4))), wherein the processor is configured to:
receive sensor data; and
use the sensor data to detect that the abnormality has occurred.

(((6)))

The information processing system according to any one of (((3))) to (((5))), wherein the processor is configured to:
in a case where the abnormality has not occurred, generate the accompanying information without including the identification information regarding the disallowed target object and the allowed target object.

(((7)))

The information processing system according to any one of (((1))) to (((6))), wherein the processor is configured to:
transmit the accompanying information to an outside via a communication unit.

(((8)))

The information processing system according to (((7))), wherein the processor is configured to:
display the accompanying information to be transmitted to the outside on a predetermined display unit.

(((9)))

The information processing system according to any one of (((1))) to (((8))),
wherein the accompanying information includes at least one of skeleton information regarding the target object or object information regarding an object other than the target object.

(((10)))

The information processing system according to (((9))),
wherein the skeleton information or the object information includes recognition probability information recognized from the image data.

(((11)))

The information processing system according to any one of (((1))) to (((10))),
wherein the identification information includes at least one of a name of the target object or an image showing the target object.

(((12)))

A non-transitory computer readable medium storing an information processing program causing a computer to execute a process comprising:
acquiring image data indicating a captured image; and
generating, in a case where the image shows a disallowed target object whose identification information for identifying an individual is not allowed to be provided, accompanying information of the image data without including the identification information regarding the disallowed target object.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
acquire image data indicating a captured image; and
in a case where the image shows a disallowed target object whose identification information for identifying an individual is not allowed to be provided, generate accompanying information of the image data without including the identification information regarding the disallowed target object.

2. The information processing system according to claim 1, wherein the processor is configured to:
in a case where the image shows an allowed target object whose identification information is allowed to be provided, generate the accompanying information including the identification information regarding the allowed target object.

3. The information processing system according to claim 2, wherein the processor is configured to:
in a case where a predetermined abnormality occurs and the allowed target object is shown in the image, generate the accompanying information including the identification information regarding the allowed target object.

4. The information processing system according to claim 3, wherein the processor is configured to:
detect that the abnormality has occurred using the image data.

5. The information processing system according to claim 3, wherein the processor is configured to:
receive sensor data; and
use the sensor data to detect that the abnormality has occurred.

6. The information processing system according to claim 3, wherein the processor is configured to:
in a case where the abnormality has not occurred, generate the accompanying information without including the identification information regarding the disallowed target object and the allowed target object.

7. The information processing system according to claim 1, wherein the processor is configured to:
transmit the accompanying information to an outside via a communication unit.

8. The information processing system according to claim 7, wherein the processor is configured to:
display the accompanying information to be transmitted to the outside on a predetermined display unit.

9. The information processing system according to claim 1,
wherein the accompanying information includes at least one of skeleton information regarding the target object or object information regarding an object other than the target object.

10. The information processing system according to claim 2,
wherein the accompanying information includes at least one of skeleton information regarding the target object or object information regarding an object other than the target object.

11. The information processing system according to claim 3,
wherein the accompanying information includes at least one of skeleton information regarding the target object or object information regarding an object other than the target object.

12. The information processing system according to claim 4,
wherein the accompanying information includes at least one of skeleton information regarding the target object or object information regarding an object other than the target object.

13. The information processing system according to claim 5,
wherein the accompanying information includes at least one of skeleton information regarding the target object or object information regarding an object other than the target object.

14. The information processing system according to claim 6,
wherein the accompanying information includes at least one of skeleton information regarding the target object or object information regarding an object other than the target object.

15. The information processing system according to claim 7,
wherein the accompanying information includes at least one of skeleton information regarding the target object or object information regarding an object other than the target object.

16. The information processing system according to claim 8,
wherein the accompanying information includes at least one of skeleton information regarding the target object or object information regarding an object other than the target object.

17. The information processing system according to claim 9,
wherein the skeleton information or the object information includes recognition probability information recognized from the image data.

18. The information processing system according to claim 1,
wherein the identification information includes at least one of a name of the target object or an image showing the target object.

19. A non-transitory computer readable medium storing an information processing program causing a computer to execute a process comprising:
acquiring image data indicating a captured image; and
generating, in a case where the image shows a disallowed target object whose identification information for identifying an individual is not allowed to be provided, accompanying information of the image data without including the identification information regarding the disallowed target object.

20. An information processing method comprising:
acquiring image data indicating a captured image; and
generating, in a case where the image shows a disallowed target object whose identification information for identifying an individual is not allowed to be provided, accompanying information of the image data without including the identification information regarding the disallowed target object.
